(19) United States
(12) Patent Application Publication
(10) Pub. No.: US 2011/0109378 A1
(43) Pub. Date: May 12, 2011

(54) Method and Device For Supplying Power to a Microelectronic Chip

(75) Inventors: Thomas Buechner, Boeblingen (DE); Andreas Bieswanger, Boeblingen (DE); Harald Folberth, Boeblingen (DE); Andreas Huber, Boeblingen (DE); Jochen Supper, Boeblingen (DE)

(73) Assignee: INTERNATIONAL BUSINESS MACHINES CORPORATION, Armonk, NY (US)

(21) Appl. No.: 12/942,092

(22) Filed: Nov. 9, 2010

(30) Foreign Application Priority Data
Nov. 11, 2009 (EP) 09175677.5

(51) Int. Cl. G05F 3/02

(52) U.S. Cl. 327/540

(57) ABSTRACT

A method and a device for supplying power to one or more microelectronic chips. The method comprises the steps of reading a process characteristic parameter associated with the chip from a non-volatile storage, wherein the process characteristic parameter represents a manufacturing process characteristics of the chip; determining a minimal voltage (VDD_min) based on the parameter; and supplying electric power to the chip (10) with the minimal voltage (VDD_min). The device includes a hardware portion, and a firmware portion wherein the firmware portion includes a unit for determining a minimal voltage (VDD_min) based on a process characteristic parameter of the one or more chips.

### CROSS REFERENCE TO RELATED APPLICATION

This application claims priority under 35 U.S.C. §119 from European Patent Application No. 09175677.5 filed Nov. 11, 2009, the entire contents of which are incorporated herein by reference.

### BACKGROUND OF THE INVENTION

1. Field of the Invention

The invention relates to a microelectronic chip, and more specifically, to a method and a device for supplying power to a chip.

2. Description of the Related Art

Electric power consumption has become one of the key issues in today's computer systems. Increasing energy costs, environmental issues and power supply and cooling problems are driving the need for power efficient design of these systems. Since electrical power is a square function of the electrical voltage, voltage scaling is one of the most efficient levers to reduce power consumption of a computer system.

A self-adjusting power scheme for optimal power reduction of microelectronic integrated circuits (ICs) such as microelectronic chips is disclosed in the internet publication IPCOM000031185D published on Sep. 16, 2004, on www.ip.com/pubview/IPCOM000031185D. The scheme is mainly used for processors (e.g. Power, Cell . . . ) with a fixed voltage classification of each chip. Different part numbers or voltage values are stored on-chip, e.g. in a fuse area.

A centralized voltage identification bits (VID) controller determines a voltage value which is sent to a voltage regulation module. A number of items are programmed into the fuses area of the chip at the time of manufacture, particularly during manufacturing test of the chip. Information read from the fuse area may include one or more of the following items: temperature, voltage at the pin, a PSRO (performance screen ring oscillator) value or multiple PSRO values (e.g. one at idle, one at maximum demand of power, one at a demand in between), expected PSRO loss between idle and maximum demand, expected PSRO loss between low temperature and high temperature (e.g. one for idle and one for maximum demand), minimum voltage required, precise value of an internally generated reference voltage (or multiple values of this, e.g. one at low temperature, one at high temperature etc.), or other items generally used to measure an internal device performance and demand.

The internal device performance may include information on how fast and under what conditions the chip is running. The demand may include information on whether it is near minimum current demand, maximum current demand, or between minimum and maximum demand. The controller is coupled to a VID driver which outputs VID bits based on the above mentioned items to the voltage regulation module which outputs a VDD value accordingly.

According to the related art, additional on-chip hardware is required for real-time sensing and controlling. The voltage scaling is applicable for processor chips by changing the supply voltage based on processor work load or operating conditions. By scaling the voltage dynamically, the supply voltage is decreased in situations when there is less processing performance needed or when the power consumption has to be reduced, such as to save battery life. Since the gate switching speed is proportional to the supply voltage, this often goes together with decreasing the clock frequency, known as Dynamic Voltage and Frequency Scaling (DVFS). However, there are many non-processor IC chips in a computer, especially for data transfer and fanout to memory, as well as peripheral I/O ICs (I/O=input-output). These IC chips usually have to support a fixed data transfer rate defined by bus protocol standards, so the usability of a DVFS method as described above is very limited for such IC chips.

### SUMMARY OF THE INVENTION

According to an aspect of the invention, a method for supplying power to one or more microelectronic chips is provided. The method includes the steps of reading a process characteristic parameter associated with the chip from a non-volatile storage, wherein the process characteristic parameter represents a manufacturing process characteristics of the chip; determining a minimal voltage (VDD_min) based on the parameter; and supplying electric power to the chip with the minimal voltage (VDD_min).

According to another aspect of the invention a device for supplying power to one or more microelectronic chip is provided. The device includes a hardware portion and a firmware portion, wherein the firmware portion includes a unit for determining a minimal voltage (VDD_min) based on a process characteristic parameter of the one or more chips.

It is an object of the invention to provide an improved method for supplying power to a microelectronic chip, particularly for a multitude of chips in a system, which allows for a reduction of the power consumption of the system including the microelectronic chip.

Another object is to provide a device for supplying power to a microelectronic chip.

These objects are achieved by the features of the independent claims. The other claims, the drawing and the specification disclose advantageous embodiments of the invention.

### BRIEF DESCRIPTION OF THE DRAWINGS

The present invention together with the above-mentioned and other objects and advantages may best be understood from the following detailed description of the embodiments, but not restricted to the embodiments, wherein is shown in:

FIG. 1 a block diagram of an embodiment of the invention including manufacturing test, functional card test and system characterization illustrating preparation of the method;

FIG. 2 a block diagram illustrating an implementation of the embodiment of FIG. 1 illustrating system usage;

FIG. 3 a first procedure of firmware tasks; and

FIG. 4 an alternative procedure of firmware tasks.

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

### DETAILED DESCRIPTION OF THE PREFERRED EMBODIMENT

A method for supplying power to one or more microelectronic chips is proposed including the steps of: reading a process characteristic parameter associated with the chip from a non-volatile storage, wherein the process characteristic parameter represents a manufacturing process characteristics of the chip; determining a minimal voltage based on the process characteristic parameter; and supplying electric power to the chip with the minimal voltage.

Favorably, power reduction of 20% or more can be achieved with a minimum of design effort. No additional on-chip hardware is needed. Frequency scaling is not involved, which makes the method also feasible for non-processor IC chips. Expediently, the method can be controlled by firmware. The method can be easily adapted to new characterization results for microelectronic chips. Granular changes can be made anytime, as granularity can be determined by the hardware used, e.g. a voltage regulator or a digital/analog converter. The granularity reflects how fine the chips can be subdivided according to their required minimal voltage. The finer the granularity the more accurate can the proper minimal voltage be chosen for each chip. The present invention allows easy fallback to safe operating conditions in case of failures.

An additional advantage is that chips can be supplied with a minimum supply voltage independent from other chips in a system. Usually, process variations during manufacturing affect many characteristics of an IC chip, one of which is the gate switching speed. For this reason, the supply voltage is usually kept at a fixed value that is set high enough to guarantee an error-free behaviour for all manufactured chips, even for those chips manufactured under worst case manufacturing process conditions. A large number of chips are not manufactured under worst case conditions and could actually run at a much lower supply voltage which would result in saving a substantial amount of power. The invention allows a reduction to the supply voltage for such chips, as the supply voltage for a chip in a system enclosing a multitude of chips is adapted for each chip individually.

In a favorable method step, the minimal voltage based on the process characteristic parameter can be read from a look-up table. The lookup table can be generated during a system characterization procedure which is a typical task in a system which includes one or more chips.

A simple way for providing a correlation between the process characteristic parameter, e.g. a PSRO value, and the minimal voltage is possible according to a favorable method step, when the minimal voltage based on the process characteristic parameter can be determined by calculating the minimal voltage from a functional correlation between the minimal voltage and the process characteristic parameter associated with the chip.

Expediently, the non-volatile storage may be powered pre to initializing the chip. Power-on of the complete chip with a higher supply voltage than necessary can be avoided.

An expedient embodiment of the invention includes the steps of powering the non-volatile storage with a stand-by voltage; reading the process characteristic parameter associated with the chip from the non-volatile storage; determining the minimal voltage based on the process characteristic parameter; setting a voltage device to the voltage to the minimal voltage based on the read process characteristic parameter; and supplying power to the chip with the minimal voltage. An appropriate standby voltage can be used which is supplied only to the non-volatile storage for reading the process characteristic parameter.

Powering on the non-volatile storage and reading the process characteristic parameter associated with the chip from the non-volatile storage and determining the minimal voltage based on the process characteristic parameter may be steps performed by a firmware. These steps can be performed each time at power-on before the chip is initialized.

An expedient alternative embodiment of the invention includes the steps of setting a voltage device to a first voltage which is equal or higher than the minimum voltage; powering the non-volatile storage with the first voltage; reading the process characteristic parameter associated with the chip from the non-volatile storage; determining the minimal voltage based on the process characteristic parameter; setting the voltage device to the minimal voltage based on the read process characteristic parameter; and supplying power to the chip with the minimal voltage. In this case, a standby voltage is not necessary for reading the process characteristic parameter, e.g. the PSRO value, from the non-volatile storage.

According to a favorable embodiment, the voltage can be provided by a programmable voltage regulator. The programmable voltage regulator can be easily set to a desired output voltage such as the minimum supply voltage for the chip.

In another expedient embodiment, each chip in a system of a multitude of chips can be supplied with its individual minimal voltage. In this way, an overall energy consumption of the system can be reduced as each chip can be addressed individually.

It is of advantage if the process characteristic parameter includes a cycle time of a performance screen ring oscillator provided on the chip. Such a structure is usually available on a microelectronic chip for revealing chip performance.

According to another aspect of the invention, a device for supplying power to one or more microelectronic chips is proposed, particularly using the inventive method as described above, the device including a hardware portion and a firmware portion. The firmware portion includes a unit for determining a minimal voltage based on a process characteristic parameter, e.g. a PSRO value, of the one or more chips.

Advantageously, the hardware portion may include a chip including a non-volatile storage, a programmable voltage regulator, and a control structure coupled to the chip and to the programmable voltage regulator. Additional on-chip hardware can be avoided thus reducing the complexity of the chip and saving expensive real estate on the chip area.

According to a further embodiment, the device may be configured to adapt the minimal voltage individually for each chip of the one or more chips. Each chip can be addressed individually so that chips from different areas of a manufacturing window can be used in the same system without superfluous energy effort. A heat load during operation of the system is reduced.

The flexibility of the chip or the system can be increased in a further embodiment when a lookup table can be provided for reading the process characteristic parameter associated with the chip from the non-volatile storage. The lookup table can easily be adapted for changes in the behavior or characteristics of chips of the system including a multitude of chips. For instance, if it is found during characterization that a certain number of chips (e.g. from a certain wafer lot) shows a non-linear behavior of the minimal supply voltage VDD_min over a certain range of PSRO values, the lookup table can be changed accordingly to reflect this behavior. The look up table can also be associated with other process characteristic parameters of the chip such as a wafer identification (wafer ID) which discloses the particular wafer from which a certain chip originates and/or coordinates of the chip on the wafer during manufacturing. Such parameters can be included in the look up table additional to the PSRO value. When selecting the minimal supply voltage for a chip such parameters can be considered too.

According to another favorable embodiment, the one or more chips can be coupled to a voltage source supplying a standby voltage. As a result, the non-volatile storage can be powered independently from the chip yielding additional savings in the overall energy consumption of the chip or a system including a multitude of chips.

Favorably, the supply voltage of each chip in a system can be separately adapted to manufacturing process conditions of the specific chip. By automatically selecting the lowest possible supply voltage for each individual chip employed in the system the power consumption of a computer system can be reduced at a large scale.

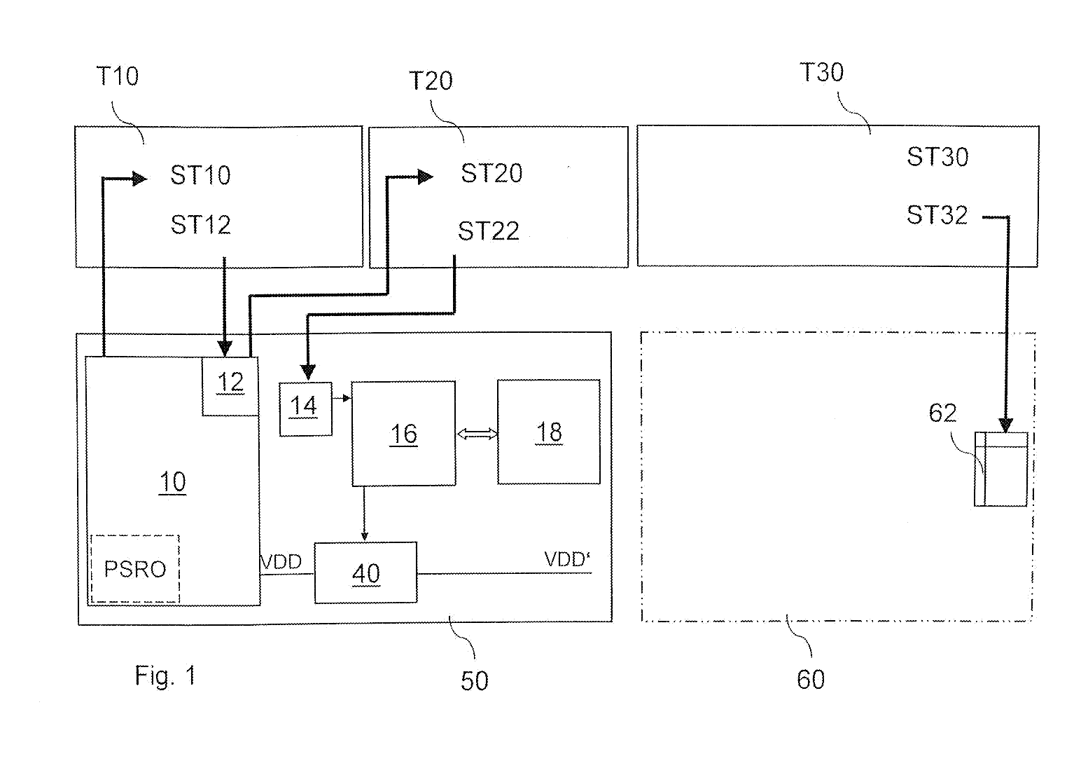

FIG. 1 illustrates block diagram of an embodiment of the invention including manufacturing test T10 of a chip 10, functional card test T20 and system characterization T30 illustrating preparative steps for a method for supplying power to one or more microelectronic chips.

The method and the device according to the invention are based on favorable steps like storing in a non-erasable area on each chip information about its manufacturing process characteristics, reading out the specific manufacturing process characteristics information form the chip through a control structure before powering-on the chip, correlating the process characteristics information with a predetermined minimum supply voltage VDD and setting up the chip's static supply voltage to the minimum allowed value through a control structure.

A common method to determine the manufacturing process characteristics of a chip is the usage of a PSRO (PSRO=performance screen ring oscillator) on the chip whose cycle time is measured (step ST10) at manufacturing test T10, resulting in a PSRO value characteristic for the chip 10. According to the invention, the information is stored (step ST12) in a non-volatile storage 12 in a non-erasable area on the chip 10 as a reference. The non-volatile storage 12 can be understood as an electronic chip identification (ECID). The non-volatile storage 12 may contain additional information such as a wafer identification associated with the chip 10 identifying from which wafer a particular chip 10 originates, and/or coordinates of the chip 10 on the wafer during the manufacturing process and the like. Such additional information can be read together with the PSRO value of the chip 10.

During the functional card test T20 of the chip 10 (after assembling the chip onto a card or a printed circuit board) the manufacturing process characteristics, particularly the PSRO values, is read from the on-chip non-volatile storage 12 (step ST20) and stored in step ST22 in a non-volatile storage 14, particularly a SEEPROM (serial electrically erasable programmable read-only memory) which is coupled to a control structure including a FRU gate array 16 and a flexible service processor 18. The non-volatile storage 14 is preferable on a hardware component such as a card (e.g. based on a printed circuit board PCB). The FRU gate array 16 outputs the relevant data to a programmable voltage regulator 40 which has an input with a first supply voltage VDD′ and outputs a second supply voltage VDD to the chip 10. With the SEEPROM (non-volatile storage 14) there is no need to power-on the ECID portion of the chip 10 in order to read the chip characteristics. Without the SEEPROM, it is necessary to apply a standby voltage Vstb to the ECID portion (non-volatile storage 12) of the chip 10 as well.

The device according to the invention includes a hardware portion 50 and a firmware portion 60. The hardware portion 50 includes the chip 10 including the on-chip non-volatile storage 12 and a unit PSRO for determining the cycle time of a performance screen ring oscillator as a process characteristic parameter of the chip 10, the control structure, the non-volatile storage 14 and the programmable voltage regulator 40.

The block of system characterization T30 includes the steps of correlating the manufacturing process characteristics, particularly the process characteristic parameters such as the cycle times of a performance screen ring oscillator PSRO values, with a minimal supply voltage VDD_min (step ST30) and step ST32. In step ST32 a firmware lookup table 62 is generated, e.g. including PSRO range versus supply voltage VDD, which lookup table 62 is available in the firmware portion 60. The PSRO cycle time (also called PSRO value) is determined for the whole range of PSRO values inside an allowed manufacturing process window of the chip. This correlation between the PSRO values and the minimal supply voltage VDD_min can be used later in the system to select the minimal supply voltage VDD_min for each chip 10.

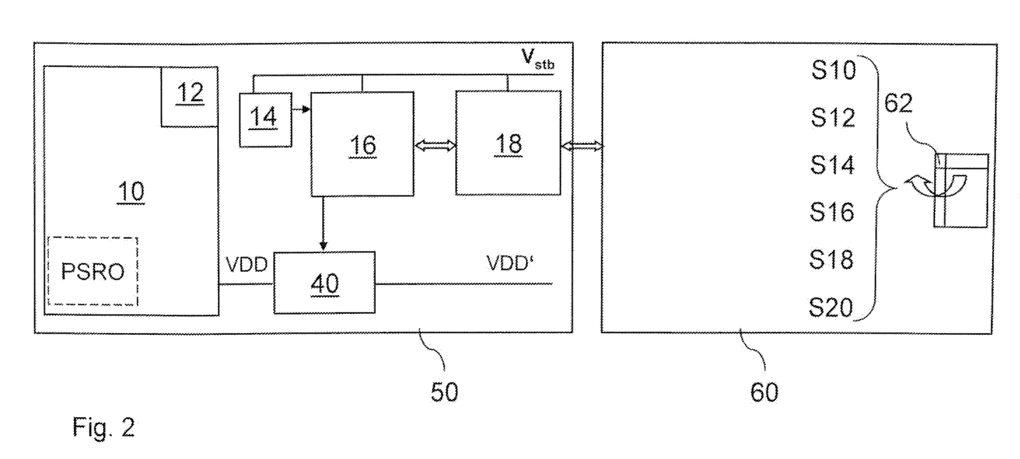

FIG. 2 depicts a block diagram illustrating the system usage, particularly tasks performed by the firmware in the firmware portion 60. In the embodiment shown, a standby voltage Vstb is provided for powering either the on-chip non-volatile storage 12 or the non-volatile storage 14 coupled to the control structure.

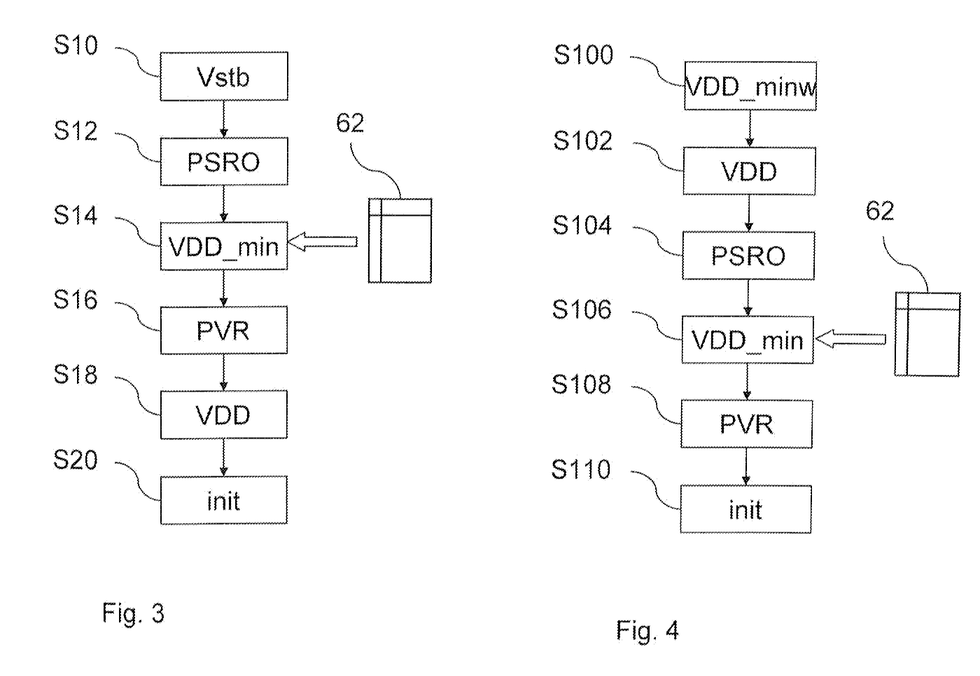

FIG. 3 and FIG. 4 illustrate tasks of the firmware when a standby voltage Vstb is provided (FIG. 3) and without a standby voltage (FIG. 4).

In FIG. 3, the standby voltage Vstb is powered on in step S10 and the PSRO value read from the non-volatile storage 14 powered by the standby voltage Vstb (or from the on-chip non-volatile storage 12 when powered by the standby voltage Vstb) in step S12. In step S14, the minimal supply voltage VDD_min for the chip is extracted from the lookup table 62. The programmable voltage regulator 40 is set to output a supply voltage VDD according to the minimal supply voltage VDD_min in step S16. In step S18 the supply voltage VDD is powered on. In step S20 the chip is initialized and ready to start its function.

In other words, the volatile storage 14 (or the non-volatile storage 12) is powered pre to initializing the chip 10.

In the alternative embodiment depicted in FIG. 4 a standby voltage is not available. Because the non-volatile storage 14 (or the on-chip non-volatile storage 12) is powered by the same supply voltage as the rest of the chip, the supply voltage VDD must be switched on first (to read the PSRO value from the non-volatile storage 14 (or the on-chip non-volatile storage 12). This requires a first step S100 in the firmware where the programmable voltage regulator is programmed with the highest minimal supply voltage VDD_minw known to support even the chips manufactured at the worst manufacturing process corner. Then the supply voltage VDD is powered on in step 102. In step 104 the PSRO value is read from the non-volatile storage 14 (or the on-chip non-volatile storage 12) and in step S106 the minimal supply voltage VDD_min associated with the PSRO value read is extracted from the lookup table 62. In step S108 the programmable voltage regulator is reprogrammed to the minimal supply voltage VDD_min that is specific for the chip in question. Then the chip is initialized in step S110 and ready for function.

A simplified way for determining the minimal supply voltage VDD_min without using a lookup table can be used if during system characterization (block T30 in FIG. 1) a linear correlation between the PSRO cycle time and the minimal supply voltage VDD_min can be determined. This correlation is then specified as a formula that can be used later on in the system by the firmware to calculate VDD_min for any given PSRO value.

The features of an expedient embodiment are

correlation of Performance Screen Ring Oscillator (PSRO) values with VDD_min (Voltage Drain Drain) or similar chip voltage (PSRO ranges vs. concrete VDD values, e.g. in table form) e.g. during system characterization;

measuring PSRO value for a dedicated chip and storing the value in an non-volatile storage of the chip, e.g. during manufacturing tests of the chip;

reading the process characteristic parameter, e.g. the PSRO value, from the chip and copying it to a non-volatile storage on a hardware component such as a card (e.g. based on a printed circuit board PCB) e.g. during functional test of the component;

during power-on phase of a computer system including the chip:

reading the PSRO value from the non-volatile storage of the hardware component and correlating the value with VDD_min (e.g. by using a lookup table generated);

using a programmable voltage regulator to power the chip with VDD_min and initializing the chip.

Preferably, the chip can be an I/O chip or another type of chip, and not necessarily a processor chip.

Advantageously, the chip 10 itself is not needed during its actual power-on for the determination of the minimal supply voltage VDD_min. So the chip does not need to contain any dedicated hardware except the non-volatile storage 12 for storing the process characteristic parameter, e.g. the PSRO value, during a manufacturing test.

1. A method for supplying power to one or more microelectronic chips, the method comprising the steps of:
reading a process characteristic parameter associated with a chip from a non-volatile storage, wherein the process characteristic parameter represents a manufacturing process characteristics of the chip;
determining a minimal voltage (VDD_min) based on the parameter; and
supplying electric power to the chip with the minimal voltage (VDD_min).

2. The method according to claim 1, wherein the minimal voltage (VDD_min) based on the process characteristic parameter is determined by calculating the minimal voltage (VDD_min) from a functional correlation between the minimal voltage (VDD_min) and the process characteristic parameter associated with the chip.

3. The method according to claim 1, wherein the minimal voltage (VDD_min) based on the process characteristic parameter is read from a look-up table.

4. The method according to claim 1, wherein the non-volatile storage is powered pre to initializing the chip.

5. The method according to claim 1, further comprising the steps of:
powering the non-volatile storage with a stand-by voltage (Vstb);
reading the process characteristic parameter associated with the chip from the non-volatile storage;
determining the minimal voltage (VDD_min) based on the process characteristic parameter;
setting a voltage device to the voltage to the minimal voltage (VDD_min) based on the read process characteristic parameter; and
supplying power to the chip with the minimal voltage (VDD_min).

6. The method according to claim 1, further comprising the steps of:
setting a voltage device to a first voltage (VDD_minw) which is equal to or higher than the minimum voltage (VDD_min);
powering the non-volatile storage with the first voltage (VDD_minw);
reading the process characteristic parameter associated with the chip from the non-volatile storage;
determining the minimal voltage (VDD_min) based on the process characteristic parameter;
setting the voltage device to the minimal voltage (VDD_min) based on the read PSRO value; and
supplying power to the chip with the minimal voltage (VDD_min).

7. The method according to claim 1, wherein the voltage is provided by a programmable voltage regulator.

8. The method according to claim 1, wherein each chip in a system of a multitude of chips is supplied with its individual minimal voltage (VDD_min).

9. The method according to claim 1, wherein the process characteristic parameter includes a cycle time of a performance screen ring oscillator (PSRO) provided on the chip.

10. A device for supplying power to one or more microelectronic chips, the device comprising:
a hardware portion; and
a firmware portion;
wherein the firmware portion comprises a unit for determining a minimal voltage (VDD_min) based on a process characteristic parameter of the one or more chips.

11. The device according to claim 10, wherein the hardware portion comprises:
a chip which includes a non-volatile storage;
a programmable voltage regulator; and
a control structure coupled to the chip and to the programmable voltage regulator.

12. The device according to claim 10, wherein the device is configured to adapt the minimal voltage (VDD_min) individually for each chip of the one or more chips.

13. The device according to claim 10, wherein a lookup table is provided for reading the process characteristic parameter associated with the chip from the non-volatile storage.

14. The device according to claim 10, wherein the one or more chips are coupled to a voltage source supplying a standby voltage (Vstb).
